(19) United States
(12) Patent Application Publication
(10) Pub. No.: US 2008/0150908 A1
(43) Pub. Date: Jun. 26, 2008

(54) Image Printing Apparatus and Method for Setting a Printing Parameter Therein

(75) Inventor: Masahiro SOMENO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/959,869

(22) Filed: Dec. 19, 2007

(30) Foreign Application Priority Data
Dec. 20, 2006 (JP) 2006-342662

(51) Int. Cl. G06F 3/041

(52) U.S. Cl. 345/173

(57) ABSTRACT

An image printing apparatus for printing an image according to a printing parameter is provided. The image printing apparatus includes a touch screen panel and a printing parameter setting unit. The touch screen panel has a display screen and a touch information acquiring unit. The acquiring unit acquires touch information representing the touching status of a stylus-shaped object to the display screen. The printing parameter setting unit sets a printing parameter of an image according to the touch information. The printing parameter setting unit has an image display controller and a handwritten character recognition unit. The image display controller displays a setting-target image on the display screen. The handwritten recognition unit recognizes a handwritten character entered by the stylus-shaped object on the setting-target image. The printing parameter setting unit set the printing parameter according to a recognized character string recognized by the handwritten recognition unit.

### CROSS-REFERENCE TO RELATED APPLICATIONS

The present application claims the priority based on Japanese Patent Application No. 2006-342662 filed on Dec. 20, 2006, the disclosure of which is hereby incorporated herein by reference in its entirety.

### BACKGROUND OF THE INVENTION

1. Field of the Invention

This invention relates to technology for setting a printing parameter in an image printing apparatus.

2. Description of the Related Art

In an image printing apparatus such as a printer or scanner/printer/copier multifunction peripheral (hereinafter also termed “MFP”), various printing parameters such as number of copies and paper size are set for printing of an image. The printing of the image is then carried out in accordance with these printing parameters. Certain printing apparatus has a liquid crystal display (LCD) for informing status of the printing apparatus to user. With this type of printing apparatus, when printing parameters are set, an image targeted for setting printing parameters is displayed on the LCD. User of the printing apparatus then set the printing parameters by operating operation buttons provided separately from the LCD, while viewing the image shown on the LCD.

To set printing parameters in this way, the user verifies the LCD and the operation buttons alternately in general. As a result, depending on the layout of the LCD and the operation buttons, there is a case that operation for setting the printing parameters is cumbersome.

### SUMMARY OF THE INVENTION

An object of the present invention is to facilitate setting of a printing parameter in an image printing apparatus.

According to an aspect of the present invention, an image printing apparatus for printing an image according to a preset printing parameter is provided. The image printing apparatus comprises a touch screen panel having a display screen and a touch information acquiring unit configured to acquire touch information, the touch information representing a touching status of a stylus-shaped object to the display screen; and a printing parameter setting unit configured to set a printing parameter of an image according to the touch information acquired by the touch information acquiring unit; wherein the printing parameter setting unit includes: an image display controller configured to display a setting-target image which is targeted for setting of the printing parameter on the display screen; and a handwritten character recognition unit configured to recognize a handwritten character according to the touch information, the handwritten character being entered by the stylus-shaped object on the display screen displaying the setting-target image, and the printing parameter setting unit set the printing parameter according to a recognized character string recognized by the handwritten character recognition unit.

With this configuration, the printing parameter to be set for the setting-target image can be set by entering a character specifying the printing parameter on the setting-target image which is displayed on the display screen of the touch screen panel. As a result, it is possible to input the printing parameter for the setting-target image without having to gaze away from the setting-target image of which printing parameter is being set, thereby making it facilitate setting of the printing parameter.

The present invention may be realized in various embodiments, for example, an image output apparatus and an image output method; a controller and a controlling method of the image output apparatus; a computer program for realizing the functions of such a apparatus or a method; a storage medium having such a computer program stored thereon; and data signals embedded in carrier waves including such a computer program.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a block diagram depicting a configuration of a printer as a first embodiment of the present invention.

FIG. 2 is a flowchart showing an image printing routine executed during printing of an image.

FIG. 3 is a flowchart showing a copy count setting routine.

FIG. 4A shows an exemplary copy count setting screen displayed on the display screen.

FIG. 4B is an illustration depicting a situation in which the user has entered number of copies.

FIG. 4C depicts the copy count setting screen displayed on the display screen after the change of the copy count setting.

FIG. 5A depicts the copy count setting screen displayed on the display screen where the number of copies is set to three.

FIG. 5B is an illustration depicting a situation in which the user has touched the display screen with the back end of the stylus.

FIG. 5C depicts the copy count setting screen displayed on the display screen after the change of the copy count setting.

FIG. 6 is a flowchart depicting the paper size setting routine.

FIG. 7A depicts an example of a paper size setting screen displayed on the display screen.

FIG. 7B is an illustration depicting a situation in which the user has entered the paper size.

FIG. 7C shows the paper size setting screen displayed on the display screen after changing of the paper size.

FIG. 8 is a flowchart depicting the copy count setting routine in the second embodiment.

FIG. 9A shows an exemplary copy count setting screen of the second embodiment displayed on the display screen.

FIG. 9B is an illustration depicting a situation in which the user has entered number of copies.

FIG. 9C depicts the copy count setting screen displayed on the display screen after changing of the copy count setting.

FIG. 10A depicts the number of copies of each image file corresponding to nine images is set to the same condition as depicted in FIG. 9A.

FIG. 10B depicts a situation in which the user has entered the number of copies.

FIG. 10C depicts the copy count setting screen displayed on the display screen after setting of the copy count setting.

FIG. 11 is a flowchart depicting the copy count setting routine in the third embodiment.

FIG. 12A depicts an example of a target file selection screen displayed on the display screen.

FIG. 12B depicts a situation in which the user has entered the number of copies.

FIG. 12C depicts the copy count setting screen displayed on the display screen after setting of the copy count setting.

FIG. 13 is a flowchart depicting the copy count setting routine in the fourth embodiment.

FIG. 14A depicts a handwritten character entered by the user on the copy count setting screen displayed on the display screen.

FIG. 14B depicts a line drawn by the user subsequent to entry of the handwritten character, for specifying a setting range for the number of copies.

FIG. 14C is an illustration depicting the copy count setting screen displayed on the display screen after setting of the number of copies.

FIG. 15A depicts a handwritten character entered by the user on the copy count setting screen displayed on the display screen.

FIG. 15B depicts user specification of images for specifying a copy count setting range subsequent to entering an handwritten character.

FIG. 15C is an illustration depicting the copy count setting screen displayed on the display screen after setting of the number of copies.

FIG. 16 is a flowchart depicting the image printing routine in the fifth embodiment.

FIG. 17 is a flowchart depicting the copy count/paper size setting routine.

FIG. 18A depicts an exemplary copy count/paper size setting screen displayed on the display screen.

FIG. 18B is an illustration depicting a situation in which user has entered the number of copies and paper size on the copy count/paper size setting screen.

FIG. 18C is an illustration depicting a dialog box displayed on the display screen.

FIG. 19 is a flowchart depicting the image printing routine in the sixth embodiment.

FIG. 20 is a flowchart depicting the copy count setting routine.

FIG. 21A shows an exemplary copy count setting screen displayed on the display screen.

FIG. 21B depicts user's operation of the PAPER tab.

FIG. 21C shows a paper setting screen displayed during execution of the paper setting routine.

FIG. 22A depicts the copy count setting screen prior to switching of the setting screen

FIG. 22B is an illustration depicting a situation when the user operates the PRINT QUALITY tab with the front end of the stylus.

FIG. 22C depicts a print quality setting screen displayed on the printing parameter setting screen.

FIG. 23A depicts the copy count setting screen prior to switching of the setting screen

FIG. 23B is an illustration depicting a situation when the user operates the TRIMMING tab with the front end of the stylus.

FIG. 23C depicts a trimming setting screen displayed on the printing parameter setting screen.

### DESCRIPTION OF THE PREFERRED EMBODIMENT

Embodiments of the present invention will be described below in the following sequence:
A. First Embodiment
B. Second Embodiment
C. Third Embodiment
D. Fourth Embodiment
E. Fifth Embodiment
F. Sixth Embodiment
G. Modifications

### A. First Embodiment

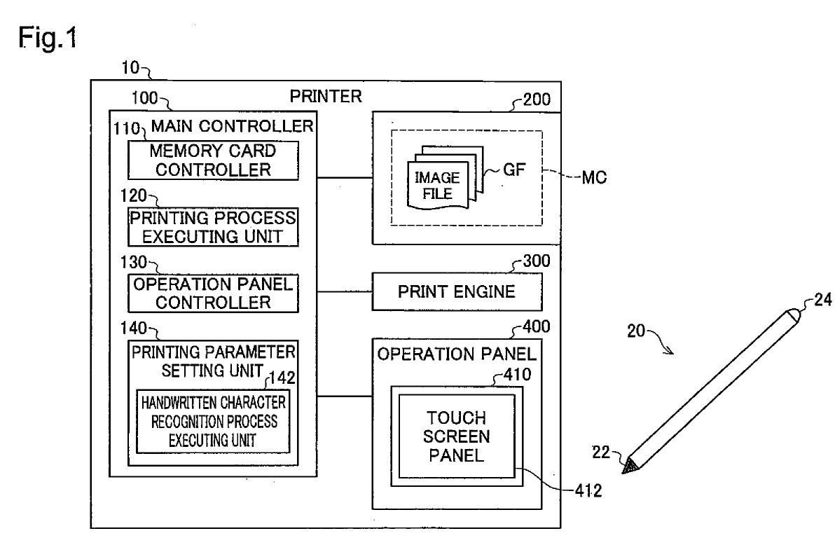

FIG. 1 is a block diagram depicting a configuration of a printer as a first embodiment of the present invention. The printer 10 includes a main controller 100, a memory card slot 200, a print engine 300, and an operation panel 400.

The main controller 100 has a memory card controller 110, a printing process executing unit 120, an operation panel controller 130, and a printing parameter setting unit 140. The printing parameter setting unit 140 includes a handwritten character recognition process executing unit (hereinafter termed simply “handwritten character recognition unit”) 142. The main controller 100 is constituted as a computer which includes a central processing unit (CPU) and memory, not shown. The CPU realizes functions of the various units belonging to the main controller 100 by executing programs stored on the memory. The printing parameter setting unit 140 sets various parameters (printing parameters) for printing an image with the printer 10. Setting of the printing parameters by the printing parameter setting unit 140 will be discussed later.

The memory card slot 200 is a mechanism for accepting a memory card MC. The memory card controller 110 stores a file on the memory card MC inserted into the memory card slot 200, or reads a file stored on the memory card MC. It is also acceptable for the memory card controller 110 to have only the function of reading a file stored on the memory card MC. In the example of FIG. 1, multiple image files GF are stored on the memory card MC which is inserted into the memory card slot 200.

The print engine 300 is a printing mechanism for executing printing according to print data supplied thereto. The print data supplied to the print engine 300 is generated by the printing process executing unit 120. To generate the print data, the printing process executing unit 120 acquires an image data from an image file GF on the memory card MC which is read with the memory card controller 110, and performs a color conversion and halftoning process on the acquired image data. The print data may be generated from image data supplied from a digital still camera, a computer, or other external device which are connected via a USB connector (not shown). It is also acceptable that the print engine 300 performs the color conversion and halftoning process instead of the printing process executing unit 120.

The operation panel 400 has a touch screen panel 410, as well as a operation switch and an indicator lamp, not shown. The touch screen panel 410 has a display screen 412 for displaying an image. The touch screen panel 410 is able to detect touch of a stylus 20, which is provided with the printer 10, to the display screen 412. Specifically, the touch screen panel 410 is able to detect where the touch location of the stylus 20 is situated within the display screen 412, as well as whether the display screen 412 is touched by front end 22 or back end 24 of the stylus 20. The touch screen panel 410 accumulates a time series of these detected results, and supplies the accumulated results to the operation panel controller 130 as touch status information. The operation panel controller 130 informs various messages to the user by displaying an image on the display screen 412, or by controlling illumination status of the indicator lamp. The user can issue various instructions to the printer 10 by operating the operation switch or the stylus 20 while viewing the indicator lamp or the image displayed on the display screen 412.

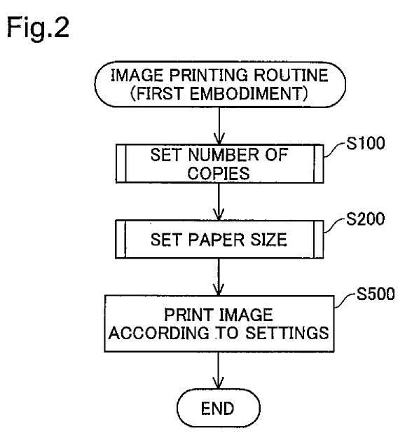

FIG. 2 is a flowchart showing an image printing routine executed during printing of an image. This image printing routine is executed, for example, when the user issues to the printer 10 an instruction for printing an image file GF stored on the memory card MC (FIG. 1) by operating the touch screen panel 410 or the operation switch (not shown) provided to the operation panel 400 (FIG. 1). Since the image contained in the image file GF is the image targeted for printing, the image can also be termed a “printing-target image.”

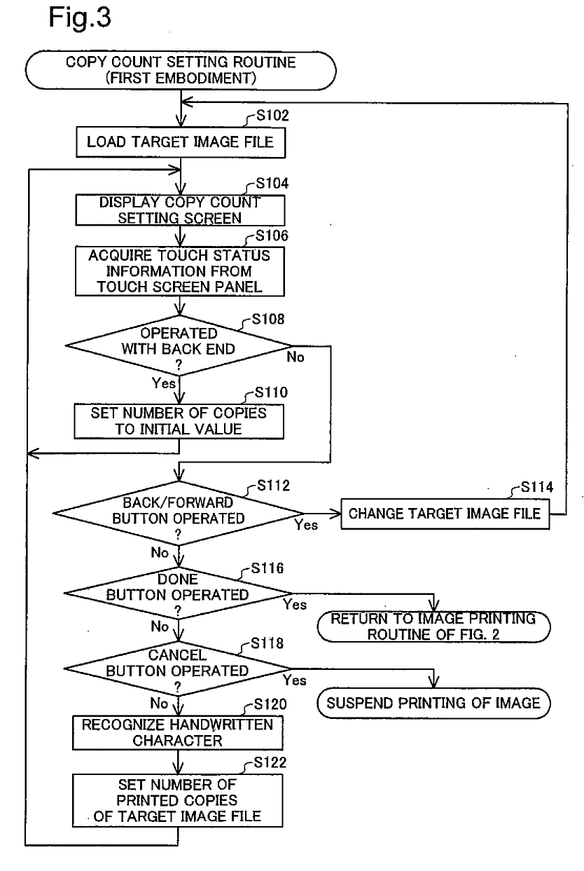

In Step S100, the printing parameter setting unit 140 sets the number of copies (copy count) of each of the multiple image files GF stored on the memory card MC. FIG. 3 is a flowchart showing a copy count setting routine executed in Step S100.

In Step S102, from among the multiple image files GF, which are stored on the memory card MC, the printing parameter setting unit 140 (FIG. 1) loads an image file targeted for setting the copy count (target image file).

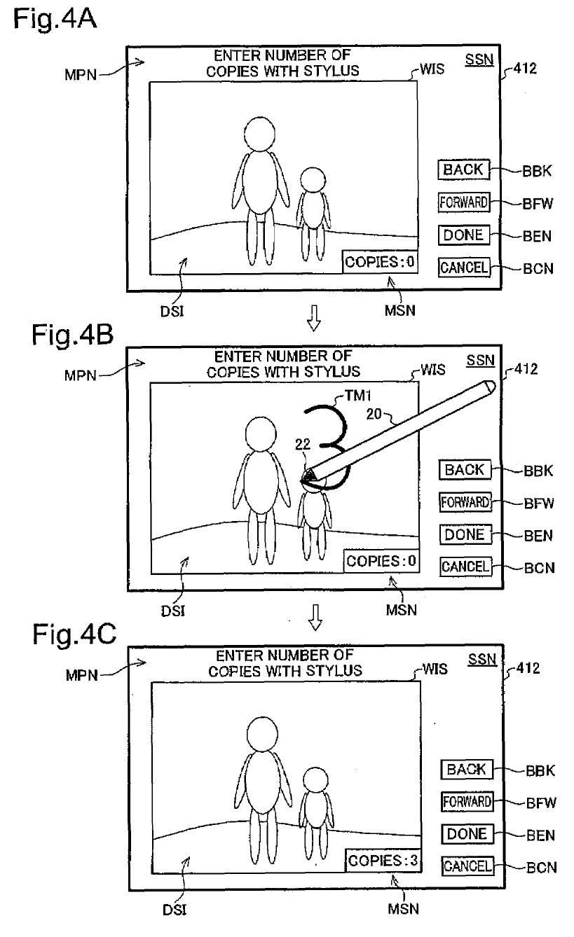

In Step S104, the printing parameter setting unit 140 displays a copy count setting screen for setting the number of copies on the display screen 412. The copy count setting screen includes the image contained in the image file which is loaded in Step S102. FIG. 4A shows an exemplary copy count setting screen SSN displayed on the display screen 412 in Step S104. Since the printing parameter setting unit 140 displays on the display screen 412 of touch screen panel 410 the image of which printing parameters are to be set, the printing parameter setting unit 410 can be considered to function as an image display controller.

As shown in FIG. 4A, the copy count setting screen SSN includes a message MPN prompting the user to enter the number of copies; four buttons BBK, BFW, BEN, BCN; and an image display area WIS. The image contained in the image file of which number of copies is to be set (i.e. a target image) DSI is displayed in the image display area WIS. In the image display area WIS, a copy count setting message MSN notifying the user of the current copy count setting value for the image file corresponding to the target image DSI is superimposed over the target image DSI. Hereinbelow, the number of copies (copy count) of an image file that corresponds to a specific image is also referred to as the number of copies (copy count) of the specific image. Also, printing parameters (number of copies, paper size, etc.) for an image file corresponding to a specific image is referred to as the printing parameters for the specific image, generally. In the example of FIG. 4A, the character string “COPIES: 0,” which represents the initial value of zero for number of copies, is displayed as the copy count setting message MSN.

In Step S106 of FIG. 3, the printing parameter setting unit 140 acquires touch status information representing touch status of the stylus 20 (FIG. 1). The touch status information is acquired from the touch screen panel 410 (FIG. 1) via the operation panel controller 130 (FIG. 1).

In Step S108, the printing parameter setting unit 140 determines whether the user has performed an operation with the back end 24 (FIG. 1) of the stylus 20. Specifically, through analysis of the touch status information acquired in Step S106, the printing parameter setting unit 140 determines whether the back end 24 of the stylus 20 has touched the display screen 412. If it is determined that the back end 24 of the stylus 20 has touched the display screen 412, the process advances to Step S110. On the other hand if it is determined that the back end 24 of the stylus 20 has not touched the display screen 412, the process moves to Step S112.

In Step S110, the printing parameter setting unit 140 changes the number of copies of the target image file to the initial value (0). After changing of the number of copies to the initial value, the process returns to Step S104.

In Step S112, the printing parameter setting unit 140 determines whether the “BACK” button BBK or the “FORWARD” button BFW on the copy count setting screen SSN (FIG. 4A) is operated. Specifically, through analysis of the touch status information acquired in Step S106, the printing parameter setting unit 140 determines whether the touch location of the front end 22 of the stylus 20 to the display screen 412 is inside the display area of the “BACK” button BBK and the “FORWARD” button BFW. If the touch location of the front end 22 is inside the display area of these two buttons BBK, BFW, it is determined that the “BACK” button BBK or the “FORWARD” button BFW on the copy count setting screen SSN is operated, and the process moves to Step S114. On the other hand, if the touch location of the front end 22 is outside the display area of these two buttons BBK, BFW, it is determined that neither the “BACK” button BBK nor the “FORWARD” button BFW on the copy count setting screen SSN is operated, and the process advances to Step S116.

In Step S114, the printing parameter setting unit 140 changes the target image file targeted for setting of number of copies by proceeding in order through the sequence of multiple image files GF stored on the memory card MC (FIG. 1) according to which of the two button, the “BACK” button BBK or the “FORWARD” button BFW, is operated. After the changing of the target image file, the process returns to Step S102.

In Step S116, the printing parameter setting unit 140 determines whether the “DONE” button BEN on the copy count setting screen SSN is operated. Specifically, through analysis of the touch status information acquired in Step S106, the printing parameter setting unit 140 determines whether the touch location of the front end 22 of the stylus 20 to the display screen 412 is inside the “DONE” button BEN display area. If the touch location of the front end 22 is inside the “DONE” button BEN display area, it is determined that the “DONE” button BEN is operated, and the process returns to the image printing routine of FIG. 2. On the other hand, if the touch location of the front end 22 is outside the “DONE” button BEN display area, it is determined that the “DONE” button BEN is not operated, and the process advances to Step S118.

In Step S118, the printing parameter setting unit 140 determines whether the “CANCEL” button BCN on the copy count setting screen SSN is operated. Specifically, through analysis of the touch status information acquired in Step S106, the printing parameter setting unit 140 determines whether the touch location of the front end of the stylus to the display screen 412 is inside the “CANCEL” button BCN display area. If the touch location of the front end 22 is inside the “CANCEL” button BCN display area, it is determined that the “CANCEL” button BCN is operated, whereupon the image printing routine of FIG. 2 terminates and printing of the image is suspended. On the other hand, if the touch location of the front end 22 is outside the “CANCEL” button BCN display area, it is determined that the “CANCEL” button BCN is not operated, and the process advances to Step S120.

In Step S120, the printing parameter setting unit 140 performs recognition of characters entered using the front end 22 of the stylus 20. Specifically, from the touch status information acquired in Step S106, the printing parameter setting unit 140 acquire trajectory of touch location (stroke) of the front end 22 of the stylus 20. Through character recognition performed by the handwritten character recognition process executing unit 142, the acquired stroke is converted to a character string. Conversion from the stroke to the character string may be achieved through handwritten character recognition methods known in the art.

FIG. 4B is an illustration depicting a situation in which the user has entered number of copies. The stroke TM1 of a character entered by the user (hereinafter also termed “handwritten character TM1”) is displayed at the position of the display screen 412 where the front end 22 of the stylus 20 has touched. From this handwritten character TM1, the handwritten character recognition process executing unit 142 recognizes the numeral “3.” The detection as to whether the user has finished entering a character can be made by determining whether a state without touch of the front end 22 to the display screen 412 subsequent to initial touching of the front end 22 to the display screen 412 has continued for a prescribed time period.

In Step S122 of FIG. 3, the printing parameter setting unit 140 sets the number of copies of the target image file, to a value equal to the numeral that is recognized from the handwritten character in Step S120. After the setting of the number of copies, the process returns to Step S140. The steps of the copy count setting routine of FIG. 3 are then repeatedly executed until either the “DONE” button BEN or the “CANCEL” button BCN is operated. Once the process has returned to Step S104, the copy count setting message MSN displayed on the copy count setting screen SSN (FIG. 4A through 4C) is updated to a message showing the number of copies set in Step S122.

FIG. 4C depicts the copy count setting screen SSN that is displayed on the display screen 412 in Step S104 of FIG. 3 after the change of the copy count setting according to handwritten character entered by the user in FIG. 4B. As mentioned above, the character entered by the user is recognized as the numeral “3,” and the number of copies is set to three. Therefore, the copy count setting message MSN is changed from the character string “COPIES: 0” indicating the initial value of 0, to the character string “COPIES: 3” indicating that the number of copies is three.

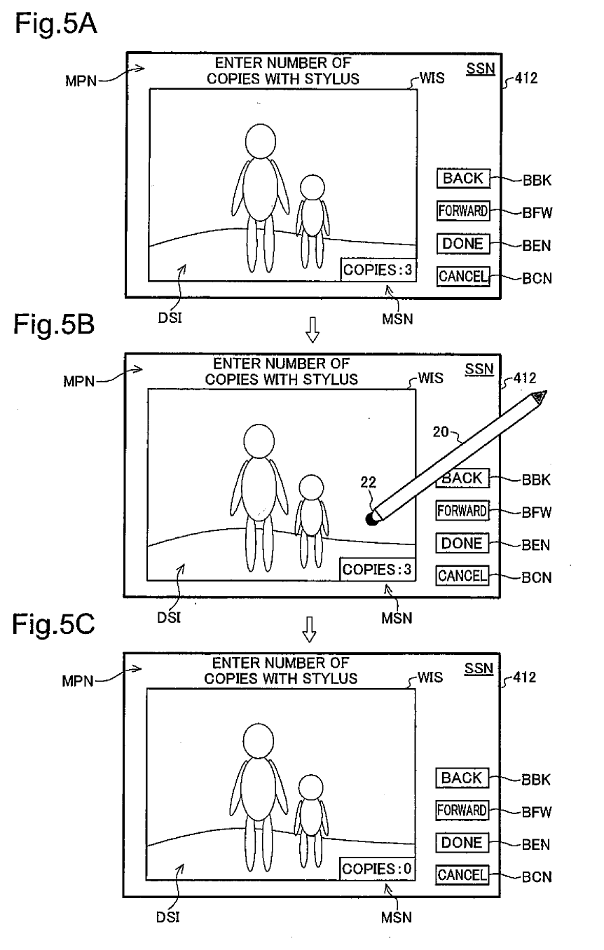

FIG. 5A is identical to FIG. 4C, and depicts the copy count setting screen SSN that is displayed on the display screen 412 where the number of copies is set to three in the example of FIG. 4C. Here, as shown in FIG. 5B, when the user touches the display screen 412 with the back end 24 of the stylus 20, in Step S108 of FIG. 3, it is determined that operation has taken place with the back end 24, and in Step S110 the number of copies is changed to the initial value of 0. Then, in Step S104, the character string “COPIES: 0” indicating that the number of copies is 0 is displayed as the printing setting message MSN, as shown in FIG. 5C.

Once the process returns from the copy count setting routine shown in FIG. 3 to the image printing routine of FIG. 2, Step S200 is executed. In Step S200, the printing parameter setting unit 140 set the paper size for each image file of which number of copies is set to one or more, from among the multiple image files GF stored on the memory card MC. However, it would also be acceptable to set paper size for each of the multiple image files GF.

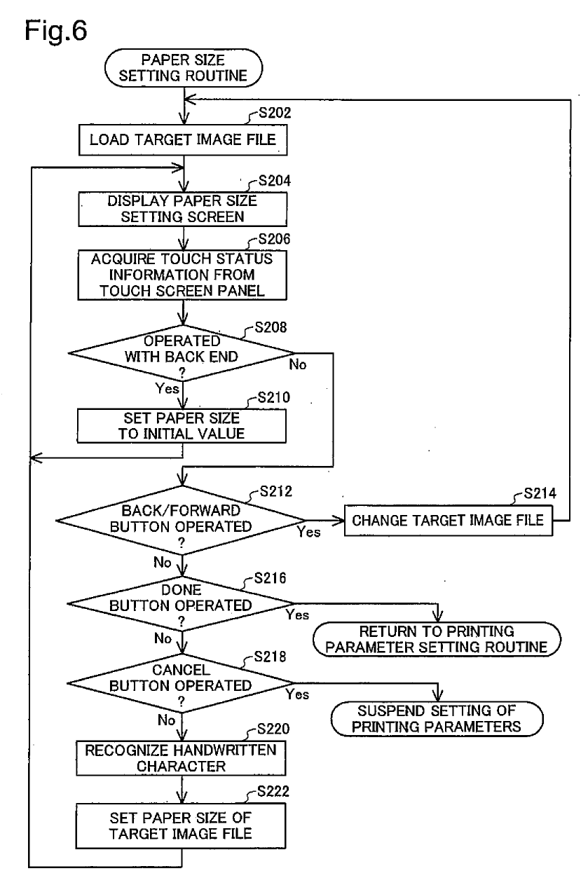

FIG. 6 is a flowchart depicting the paper size setting routine executed in Step S200. The paper size setting routine shown in FIG. 6 is similar to the copy count setting routine shown in FIG. 3, except that the printing parameter targeted for setting has changed from the number of copies to paper size. Specifically, S104, S110, and S122 of the copy count setting routine are replaced by Steps S204, S210, and S222. The other Steps S202, S206, S208, and S212 through S220 are identical to the corresponding Steps S102, S106, S108, and S112 through S120 of the copy count setting routine shown in FIG. 3. Since Step S220 is similar to Step S120 of the copy count setting routine, it will not be described herein.

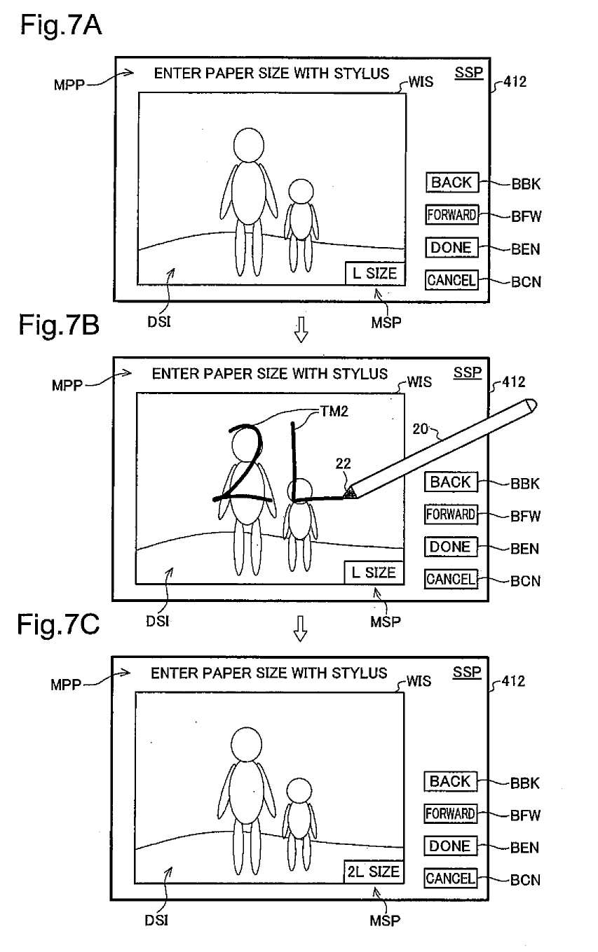

In Step S204, the printing parameter setting unit 140 a paper size setting screen for setting paper size displays on the display screen 412. FIG. 7A depicts an example of a paper size setting screen SSP displayed on the display screen 412 in Step S204.

As shown in FIG. 7A, the paper size setting screen SSP includes a message MPP prompting the user to enter the paper size; four buttons BBK, BFW, BEN, BCN; and an image display area WIS. A target image DSI of which paper size is to be set is displayed in the image display area WIS. A paper size setting message MSP notifying to the user the current setting value for paper size of the target image DSI is superimposed over the target image DSI, in the image display area WIS. In the example of FIG. 7A, the character string “SIZE L,” which indicates that the paper size is L size, is displayed as the paper size setting message MSP.

FIG. 7B is an illustration depicting a situation in which the user has entered the paper size. In this case, handwritten characters TM2 entered by the user is shown at the position of the display screen 412 where the front end 22 of the stylus 20 has touched. In Step S220 of FIG. 6, the handwritten character recognition process executing unit 142 recognizes the character string “2L” from the handwritten characters TM2.

In Step S222 of FIG. 6, the printing parameter setting unit 140 sets the printing paper size of the target image file to the value instructed by the character string that is recognized from the handwritten characters in Step S220. After setting the paper size, the process returns to Step S204, and the paper size setting message MSP displayed on the paper size setting screen SSP (FIG. 7A through 7C) is updated to a message indicating the paper size that is set in Step S222.

FIG. 7C shows the paper size setting screen SSP that is displayed on the display screen 412 after changing of the paper size according to handwritten characters entered by the user in FIG. 7B. As mentioned above, the characters entered by the user is recognized as the character string “2L,” and the paper size is set to 2L size. Thus, the paper size setting message MSP changes from the character string “SIZE L” indicating L size to the character string “SIZE 2L” indicating that the current paper size is 2L size.

In Step S218, if it is determined by the printing parameter setting unit 140 that the “DONE” button BEN (FIG. 7) is operated, the process returns to the image printing routine of FIG. 2. Once the process returns to the image printing routine, in Step S500, the printing process executing unit 120 prints the multiple image files GF stored on the memory card MC (FIG. 1), according to the number of copies and paper size set by the printing parameter setting unit 140.

In this way, in the first embodiment, the number of copies and the paper size are set for each of multiple image files GF, by entering an character over an image displayed on the display screen 412. Thus, the user can set printing parameters for individual images while viewing the image of which printing parameters are being set, making it easier to set the printing parameters. In addition, since settings can be input through handwritten character, there is no need for a key operation in order to make printing parameter settings, and printing parameters may be set more easily.

### B. Second Embodiment

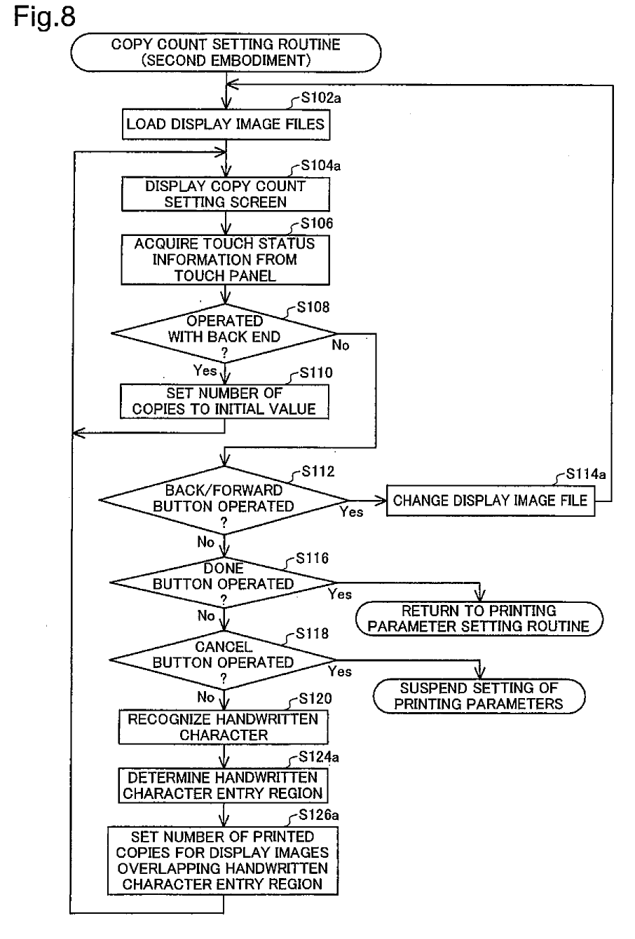

FIG. 8 is a flowchart depicting the copy count setting routine in the second embodiment. The copy count setting routine of the second embodiment differs from the copy count setting routine in the first embodiment shown in FIG. 4 in that the four Steps S102, S104, S110, and S114 are respectively replaced by Steps S102a, S104a, S110a, and S114a; and Step S122 is replaced by the two Steps S124a and S126a. In other respects the copy count setting routine is the same as in the first embodiment.

In Step S102a, from among the multiple image files GF stored on the memory card MC (FIG. 1), the printing parameter setting unit 140 loads several image files for displaying images on the display screen 412 (FIG. 1) (hereinafter also termed “display image files”).

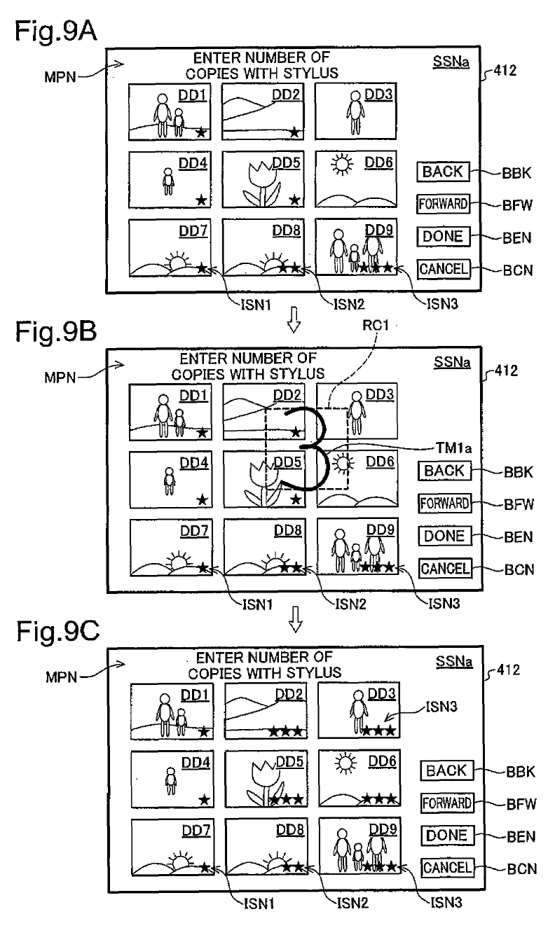

In Step S104a, the printing parameter setting unit 140 displays a copy count setting screen for setting the number of copies on the display screen 412. The copy count setting screen includes the images contained in the several image files which is loaded in Step S102a. FIG. 9A shows an exemplary copy count setting screen SSNa of the second embodiment displayed on the display screen 412 in Step S104a.

As shown in FIG. 9A, similar to the copy count setting screen SSN of the first embodiment (FIG. 4A), the copy count setting screen SSNa includes a message MPN prompting the user to enter the desired number of copies; and four buttons BBK, BFW, BEN, BCN. Images DD1 through DD9 of nine display image files that are loaded in Step S102a are displayed on the copy count setting screen SSNa. An icon indicating the copy count setting value of each image file corresponding to the displayed image is shown at lower right of each image. In the example of FIG. 9A, icons ISN1 indicating that the number of copies of each corresponding image file is 1 are displayed in five images DD1, DD2, DD4, DD5, and DD7. An icon ISN2 indicating that the number of copies of the corresponding image file is 2 is displayed in the image DD8, and an icon ISN3 indicating that the number of copies of the corresponding image file is three is displayed in the image DD9. No icon is displayed in images DD3 and DD6, for which the number of copies setting is zero. Instead of displaying icons indicating copy count setting values, an character string indicating copy count setting values may be displayed in the manner shown in FIG. 3. However, where multiple images are displayed on the display screen 412 (FIG. 1), it is preferable to display the icons in terms that the user may recognize the copy count setting easier than the character string. On the other hand, where the number of copies is large, it is preferable to display the character string in terms of requiring a smaller display area for the copy count setting values.

In Step S114a, depending on whether the operated button is the “BACK” button BBK or the “FORWARD” button BFW, the printing parameter setting unit 140 changes the display image files displayed on the display screen 412, according to the sequence of the multiple image files GF stored on the memory card MC (FIG. 1). After changing of the display image files, the process returns to Step S102a.

FIG. 9B is an illustration depicting a situation in which the user has entered number of copies. A handwritten character TM1a entered by the user is displayed at the position of the display screen 412 where the front end 22 of the stylus 20 has touched. In Step S120 of FIG. 8, the handwritten character recognition process executing unit 142 recognizes the numeral “3” from this handwritten character TM1a.

In Step S124a of FIG. 8, the printing parameter setting unit 140 identifies the entry region of the handwritten character entered by the user. Specifically, the width of the entry region is calculated according to the height of the handwritten character TM1a used in character recognition in Step S120 and the recognized character. Then the printing parameter setting unit 140 determines an area RC1 (FIG. 9B) centered to the center location of the handwritten character TM1a as the entry region of the handwritten character. The area RC1 has height equal to the height of the handwritten character TM1a and width equal to the calculated width. The width W of the entry region can be calculated, for example, from the height H of the handwritten character and from the number N of recognized characters, using the following expression (1).

W=A×H×N (1)

Here, A is a predetermined positive coefficient, and is derived empirically so as to have a value suitable for the purpose of identifying the region of character input with the stylus 20. The coefficient A may also be a function having parameters the height H of the handwritten character and/or the number N of characters.

In Step S126a, for each of the images which overlap the handwritten character entry region determined in Step S124a, the printing parameter setting unit 140 sets the number of copies of the image file corresponding to the image to the value of the numeral recognized in Step S120. After setting of the number of copies, the process returns to Step S104a. Once the process returns to Step S104a, the icons which indicate the copy count settings values, which are superimposed over the individual images DD1 through DD9 in the copy count setting screen SSNa (FIG. 9A through 9C) are changed.

FIG. 9C depicts the copy count setting screen SSNa that is displayed on the display screen 412 in Step S104a of FIG. 8, after changing of the copy count setting value according to handwritten character entered by the user in FIG. 9B. As mentioned above, the character entered by the user is recognized as the numeral “3.” As shown in FIG. 9B, of the images DD1 through DD9, the images DD2, DD3, DD5 and DD6 overlap the handwritten character entry region RC1. Therefore, the number of copies for each of the images DD2, DD3, DD5 and DD6 is set to three. Then, the icons ISN3 indicating that the number of copies is three is displayed on each of the images DD2, DD3, DD5 and DD6.

In Step S110a of FIG. 8, the last change of the number of copies is cancelled. In the example of FIG. 9A through 9C, in the case that the copy count setting value is changed from that shown in FIG. 9A to that shown in FIG. 9C in response to user's entry of a number of copies, the change is cancelled, and the status returns to that shown in FIG. 9A. Canceling of a change can be carried out by the printing parameter setting unit 140 (FIG. 1) saving the copy count setting value prior to the change in memory (not shown) of the main controller 100, and setting the number of copies using the copy count setting value saved in Step S110a.

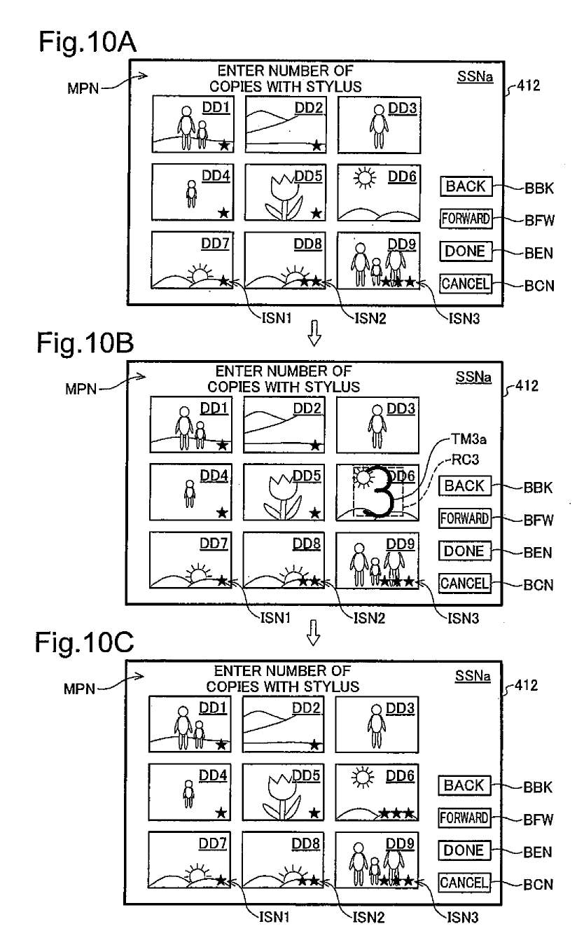

FIG. 10A through 10C depicts a situation in which handwritten character instructing the number of copies is entered by the user, in a form different from that in the example of FIG. 9A through 9C. FIG. 10A is identical to FIG. 9A, and depicts the number of copies of each image file corresponding to nine images DD1 through DD9 is set to the same condition as depicted in FIG. 9A. FIG. 10B depicts a situation in which the user has entered the number of copies. In FIG. 10B, a handwritten character TM3a (i.e. the numeral “3”) instructing the number of copies is present only on the image DD6. Therefore, the image DD6 is the only image which overlaps the handwritten character entry region RC3. As a result the number of copies of the image file which corresponds to the image DD6 is set to three. FIG. 10C depicts the copy count setting screen SSNa that is displayed on the display screen 412 after the copy count setting value is changed in this way. In the example of FIG. 10A through 10C, the number of copies is changed to three only for the image file corresponding to the image DD6. Therefore, an icon ISN3 indicating that the number of copies is three is superimposed over the image DD6 which is displayed on the copy count setting screen SSNa of FIG. 10C. The icons displayed on the other images DD1 through DD5 and DD7 and DD9, on the other hand, remain unchanged from the icons displayed in FIG. 10A.

In the second embodiment, setting of paper size is carried out through a paper size setting routine similar to the copy count setting routine in the second embodiment of FIG. 8. Because of this, the paper size setting routine in the second embodiment and the condition of setting are not be illustrated or discussed here.

In the second embodiment, the entry region of handwritten character entered by the user is identified in the above manner. Then, printing parameters of image files which correspond to images overlapping the identified entry region are modified in accordance with the entered character. As a result, the user can simultaneously change printing parameters for multiple image files by entering a handwritten character at once, making it easier to change the printing parameter settings.

The second embodiment is preferable to the first embodiment in that printing parameters for multiple image files can be changed at the same time, making it easier to change the printing parameter settings. On the other hand, the first embodiment is preferable to the second embodiment in that a single image is displayed on the display screen 412, making the user to view the displayed image easier.

In the second embodiment, the width of the entry region of the handwritten character is calculated from the height of the character and the number of characters; however, the width of the entry region could be determined by some other method instead. For example, it would be possible to determine the actual width of an entered character as the width of the entry region. However, where a character of small width (e.g. “1”) is entered, the width of the entry region may be smaller than the region of image that the user intended to set the printing parameter. Because of this, it is preferable to calculate the width of the entry region of handwritten character from the height of the character and the number of characters in terms of being able to reduce such likelihood.

In the second embodiment, in Step S110a, which is executed through touch by the back end 24 of the stylus 20 (FIG. 1), the last change is cancelled. It is also possible to execute a different process through touch by the back end 24 of the stylus 20. For example, it is possible to cancel the last change for the image file that corresponds to the image situated at the location touched by the back end 24. It is possible to reset the copy count setting to the initial value of 0 for the image file that corresponds to the image situated at the location touched by the back end 24, as well. This make it possible to restore settings for any individual image whose number of copies are set in error, in the event that the number of copies is set unintentionally because the entered text inadvertently overlapped an image that it is not intended to set.

### C. Third Embodiment

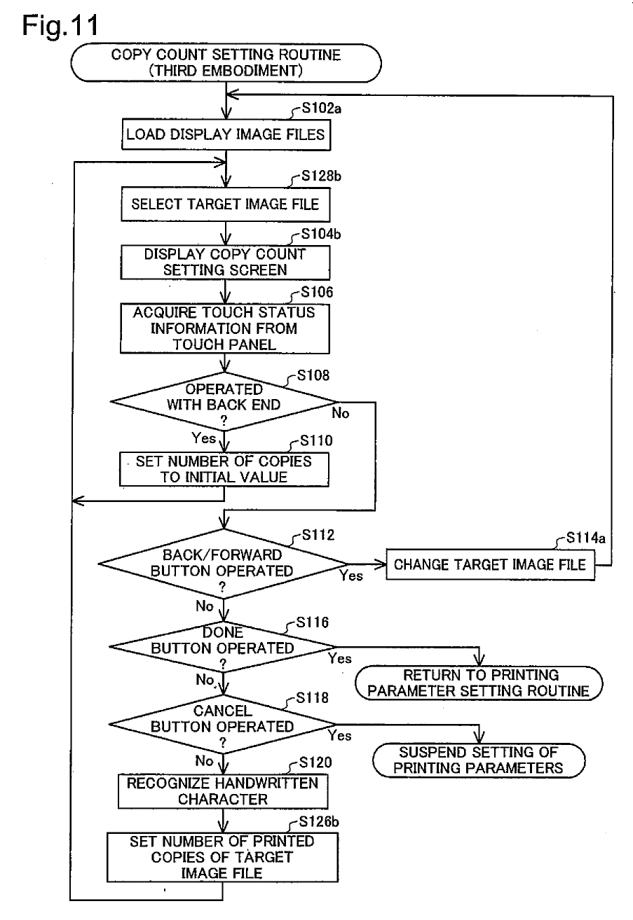

FIG. 11 is a flowchart depicting the copy count setting routine in the third embodiment. The copy count setting routine of the third embodiment differs from the copy count setting routine in the second embodiment shown in FIG. 8 in that the three Steps S102a, S104a, and S126a are respectively replaced by Steps S102b, S104b, and S126b; Step S124a is omitted; and Step S102a is followed by an additional Step S128b. In other respects the copy count setting routine is the same as in the second embodiment.

In Step S128b, from among the display image files loaded in Step S102a, the printing parameter setting unit 140 selects an image file targeted for setting of the number of copies. Specifically, a target file selection screen displaying multiple images is displayed on the display screen 412 of the touch screen panel 410 (FIG. 1), for the purpose of enabling the user to select an image or images targeted for setting of copy count. A line drawn by the user using the stylus 20 is then acquired, and among the multiple displayed images, the image files corresponding to those images through which the acquired line passes are selected as target files for setting the number of copies.

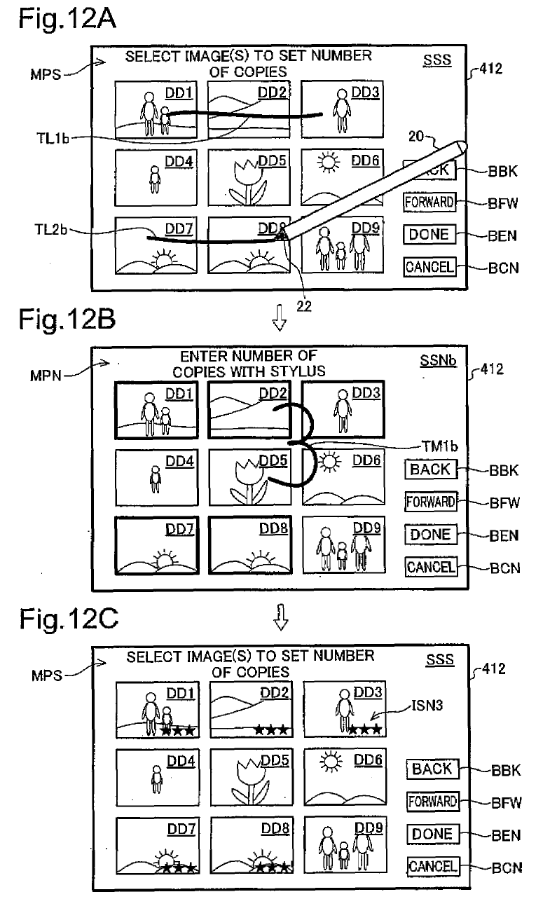

FIG. 12A depicts an example of a target file selection screen SSS displayed on the display screen 412 in Step S128b. The example of FIG. 12A shows a situation in which two lines TL1b, TL2b is drawn by the user. Of nine images DD1 through DD9 displayed on the target file selection screen SSS, these lines TL1b, TL2b overlap five images DD1 through DD3, DD7, and DD8. Thus, in the example of FIG. 12A, the image files corresponding respectively to images DD1 through DD3, DD7, and DD8 are targeted for setting the number of copies. Target file selection terminates when the user operates the “DONE” button BEN with the stylus 20. However, target file selection may be terminated in the event that a prescribed time interval has elapsed after detach of the front end 22 from the display screen.

In Step S104b of FIG. 11, the printing parameter setting unit 140 displays a copy count setting screen on the display screen 412. The copy count setting screen SSNb displayed in Step S104b is depicted in FIG. 12B. As in FIG. 9A, the copy count setting screen SSNb includes a message MPN prompting the user to enter the desired number of copies; four buttons BBK, BFW, BEN, BCN; and the nine images DD1 through DD9. For the images DD1 through DD3, DD7, and DD8 selected from the images DD1 through DD9 in Step S182b, the borders of the images DD1 through DD3, DD7, and DD8 are bolded to indicate that these images are selected as targets for setting the number of copies.

In Step S126b, the printing parameter setting unit 140 sets the number of copies of image files corresponding to the images selected in Step S128b to the value of the numeral recognized in Step S120. In the example of FIG. 12B, a handwritten character TMb1 is entered in the same manner as in FIG. 9B. Thus, the number of copies of the five images DD1 through DD3, DD7, and DD8 selected as targets for setting the number of copies and shown with bolded borders in FIG. 12B are set to three, in accordance with the numeral “3” recognized from the handwritten character TMb1.

FIG. 12C is an illustration depicting the target file selection screen SSS displayed on the display screen 412 after setting of the copy count in this way. As mentioned above, the number of copies of the five images DD1 through DD3, DD7, and DD8 through which pass the lines TL1b, TL2b drawn by the user in FIG. 12A is set to three. Therefore, the icons ISN3 indicating that the number of copies is three are superimposed over each of the images DD1 through DD3, DD7, and DD8.

In the third embodiment, setting of paper size is carried out through a paper size setting routine similar to the copy count setting routine in the third embodiment of FIG. 11. Thus, the paper size setting routine in the third embodiment and the situation of the setting are not illustrated or discussed here.

In the third embodiment, image files targeted for setting of printing parameters are pre-selected in this way through user operation of the stylus 20. The respective printing parameters for the selected target image files are then set all at once according to the handwritten character. Thus, the user can simultaneously change printing parameters for multiple image file by entering a handwritten character at once, making it easier to change the printing parameter settings.

In the third embodiment, target image files whose printing parameters are to be set at once are pre-selected, and printing parameters are set for the selected target image files. At this time, regardless of character size or placement of the images, the pre-selected image files become the image files that are set to identical printing parameters. Thus, the user can enter the printing parameter settings using characters of any size that may be entered conveniently. For this reason, the third embodiment is preferable to the second embodiment in terms of ease of input of printing parameters. On the other hand, the second embodiment is preferable to the third embodiment in that the process for selecting target image files can be dispensed with.

While the third embodiment shows an example wherein target image files of which printing parameters are to be set are pre-selected. In the instance that target image files is not selected in this way, files targeted for setting printing parameters could be determined in the manner shown in the second embodiment, for example. Such an instance in which target image files are not selected could arise when, for example, the “DONE” button BEN is operated without first entering lines TL1b, TL2b to instruct selections on the target file selection screen SSS of FIG. 12A.

### D. Fourth Embodiment

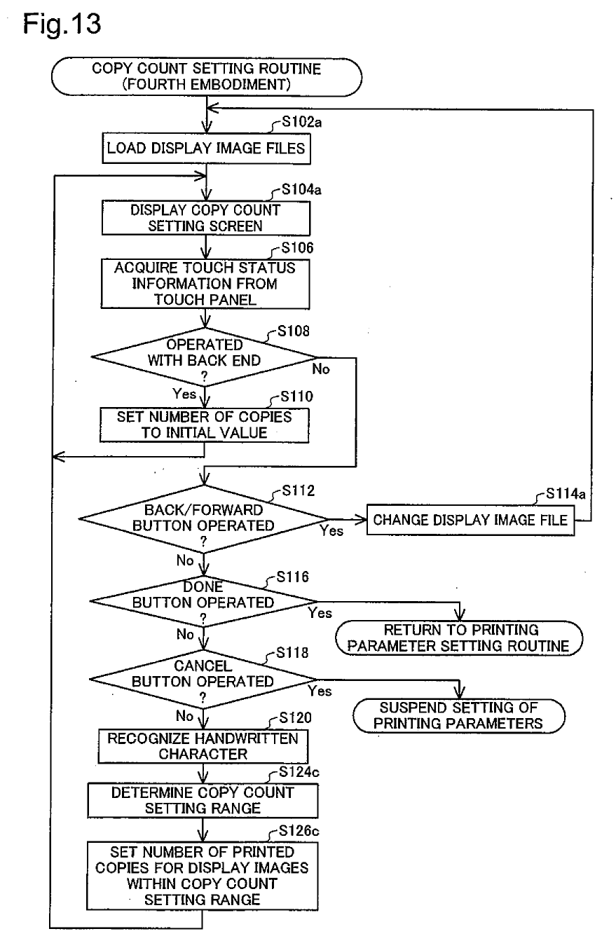

FIG. 13 is a flowchart depicting the copy count setting routine in the fourth embodiment. The copy count setting routine of the fourth embodiment differs from the copy count setting routine in the second embodiment shown in FIG. 8 in that the two Steps S124a and S126a are respectively replaced by Steps 124c and 126c. In other respects the copy count setting routine is the same as in the second embodiment.

In Step S124c, the printing parameter setting unit 140 specifies a setting range for the number of copies, that is set through handwritten character entered by the user. Specifically, from the touch status information of the stylus 20 (FIG. 1) acquired in Step S106, the printing parameter setting unit 140 acquires a continuously drawn stroke of the stylus 20, drawn subsequent to entry of the handwritten character. From the positional relationship between the acquired stroke and the images displayed on the display screen 412, the printing parameter setting unit 140 then identifies a setting range for the number of copies.

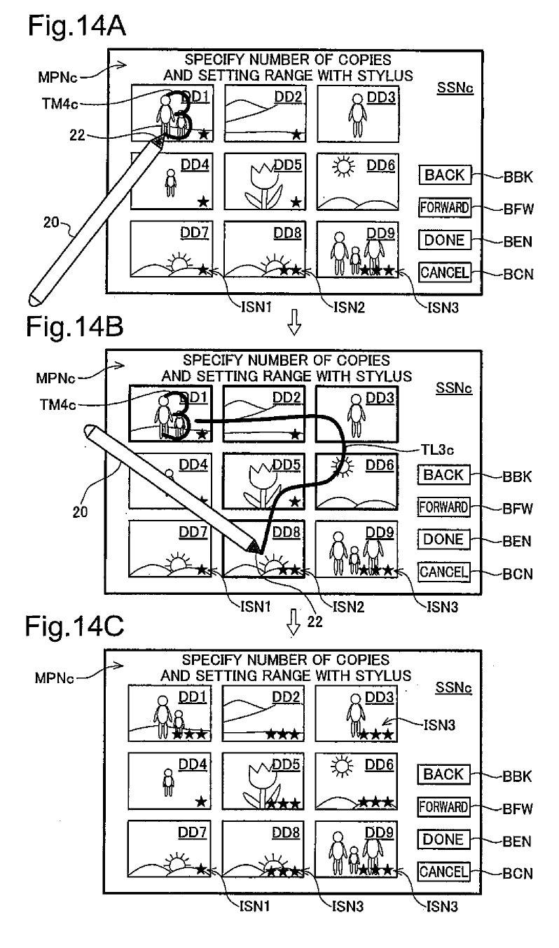

FIG. 14A depicts a handwritten character entered by the user on the copy count setting screen SSNc which is displayed on the display screen 412. The copy count setting screen SSNc of FIG. 14A differs from the copy count setting screen SSNa shown in FIG. 9A in that the message MPNc for prompting operation by the user is different, and in that handwritten character TM4c is entered on an image DD1 using the front end 22 of the stylus 20. In other respects, it is identical to the copies setting screen SSNa shown in FIG. 9A.

FIG. 14B depicts a line TL3c drawn by the user subsequent to entry of the handwritten character TM4c, for the purpose of specifying a setting range for the number of copies. The line TL3c is drawn from the image DD1 in which the handwritten character TM4c is entered, so as to pass in order through the images DD2, DD3, DD5, DD6, and DD8. Thus, in Step S124c of FIG. 13, the images DD1 through DD3, DD5, DD6, and DD8 through which the line TL3 passes are identified as the setting range for the number of copies. The handwritten character TM4c and the line TL3c can be distinguished from each other through the region of images that the stroke passes through. Specifically, a stroke made on a single image is recognized as the handwritten character TM4c, while the stroke passing through multiple images is recognized as the line TL3c. Alternatively, a stroke drawn after a prescribed time interval has elapsed from entry of the handwritten character TM4c may be recognized as the line TL3c. In this case, the line TL3c need not be displayed on the display screen 412.

In Step S126c of FIG. 13, the printing parameter setting unit 140 sets the number of copies of images in the copy count setting range identified in Step S124c according to the numeral recognized in Step S120. In the example of FIG. 14B, the number of copies of each of the images DD1 through DD3, DD5, DD6, and DD8 in the copy count setting range identified by the line TL3c is set to three, consistent with the numeral “3” recognized from the handwritten character TM4c.

FIG. 14C is an illustration depicting the copy count setting screen SSNc displayed on the display screen 412 in Step S104a, after setting of the number of copies in this manner. As mentioned above, in the example of FIG. 14, the number of copies is set to three the images DD1 through DD3, DD5, DD6, and DD8 respectively. Therefore, the icons ISN3 indicating that the number of copies is three are superimposed over each of these images DD1 through DD3, DD5, DD6, and DD8.

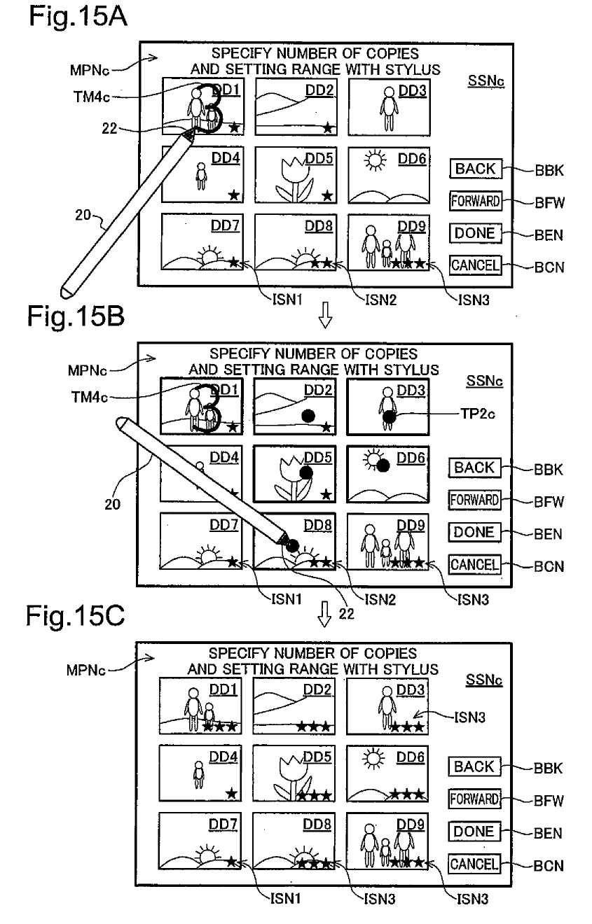

FIG. 15 depicts setting of the setting range using a different format than that of FIG. 14A through 14C. FIG. 15A is an illustration identical to FIG. 14A. FIG. 15B depicts user specification of images for which it is desired to specify a copy count setting range subsequent to entering an handwritten character TM4c. In the example of FIG. 15B, using the front end 22 of the stylus 20, the user briefly touch the areas where the images DD2, DD3, DD5, DD6, and DD8 are displayed (this is typically referred to as “tapping”). A tap mark TP2c is displayed on the tapped images DD2, DD3, DD5, DD6 and DD8 to indicate the tapped locations. The image on which the handwritten character TM4c is entered and the tapped images DD2, DD3, DD5, DD6, and DD8 are determined as the copy count setting range. By specifying a copy count setting range through tapping of images it is possible to distinguish between the handwritten character TM4c and specification of the copy count setting range, on the basis of the duration of contact time of the front end 22 of the stylus 20. Thus, in the example of FIG. 15B, it is also be possible to first specify a copy count setting range by tapping, and to then enter the number of copies.

FIG. 15C depicts the copy count setting screen SSNc displayed subsequent to setting, in accordance with the numeral “3” recognized from the handwritten character TM4, the number of copies for each of the images DD1 through DD3, DD5, DD6, and DD8 of the copy count setting range specified in the above manner. In the example of FIG. 15A through 15C, the copy count setting range (images DD1 through DD3, DD5, DD6, and DD8) and the numeral “3” recognized from the handwritten character TM4c are the same as in the example of FIG. 14A through 14C. Therefore, as in FIG. 14C, the icons ISN3 indicating that the number of copies is three is superimposed over each of these images DD1 through DD3, DD5, DD6, and DD8 in the copy count setting screen SSNc.

In the fourth embodiment, setting of paper size is carried out through a paper size setting routine similar to the copy count setting routine in the fourth embodiment of FIG. 13. Thus, the paper size setting routine in the fourth embodiment and the situation of setting are not illustrated or discussed here.

In the fourth embodiment, printing parameters entered as the handwritten character are set for all images in a printing parameter setting range that is specified in association with a handwritten character in this way. Thus, printing parameters for multiple images can be set all at once, making it easier to set printing parameters. Moreover, the printing parameter setting range is specified in a format that is distinguishable from handwritten character. Thus, erroneous setting of printing parameter setting range can be reduced, making it easier to set printing parameters for multiple images.

### E. Fifth Embodiment

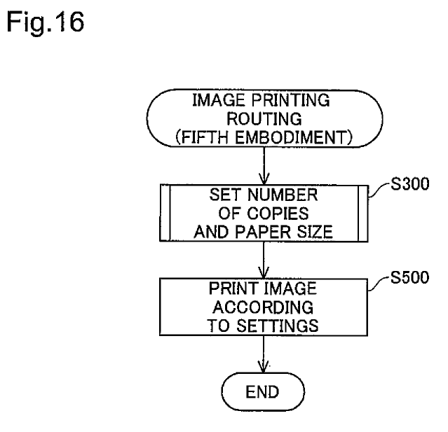

FIG. 16 is a flowchart depicting the image printing routine in the fifth embodiment. The image printing routine of the fifth embodiment differs from the image printing routine in the first embodiment shown in FIG. 2 in that the two Steps S100 and S200 are replaced by a single Step S300. In other respects the image printing routine is the same as in the first embodiment.

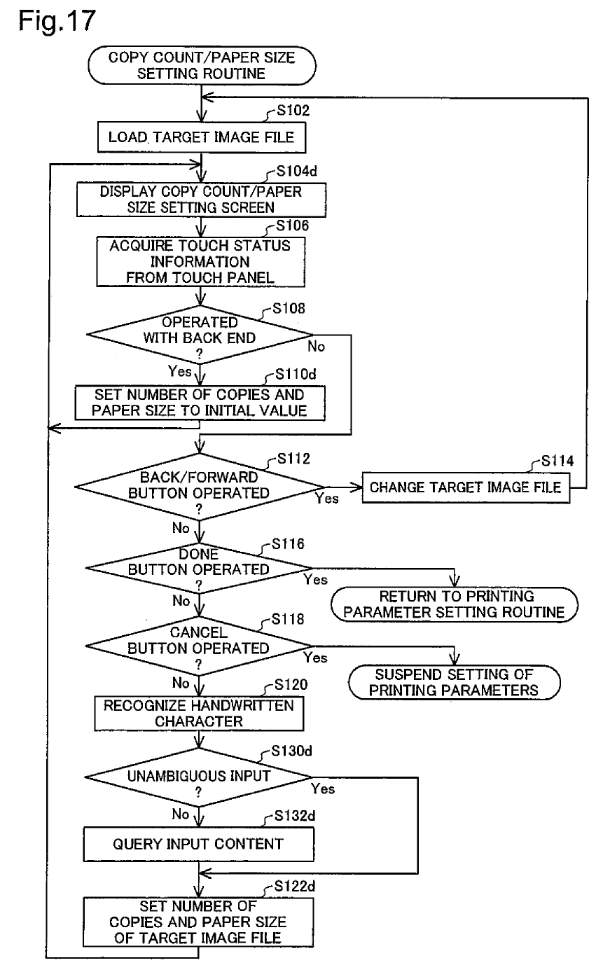

FIG. 17 is a flowchart depicting the copy count/paper size setting routine executed in Step S300. The copy count/paper size setting routine of the fifth embodiment differs from the copy count setting routine of the first embodiment shown in FIG. 3 in that Steps S104, S110, and S112 are replaced by Steps S104d, S110d, and S122d; and Step S120 is followed by two additional Steps S130d and S132d. Step S110d is similar to Step S120 of the copy count setting routine of FIG. 3, except that both the number of copies and the paper size are printing parameter settings that is restored to their initial values in Step S110d, rather than the number of copies only.

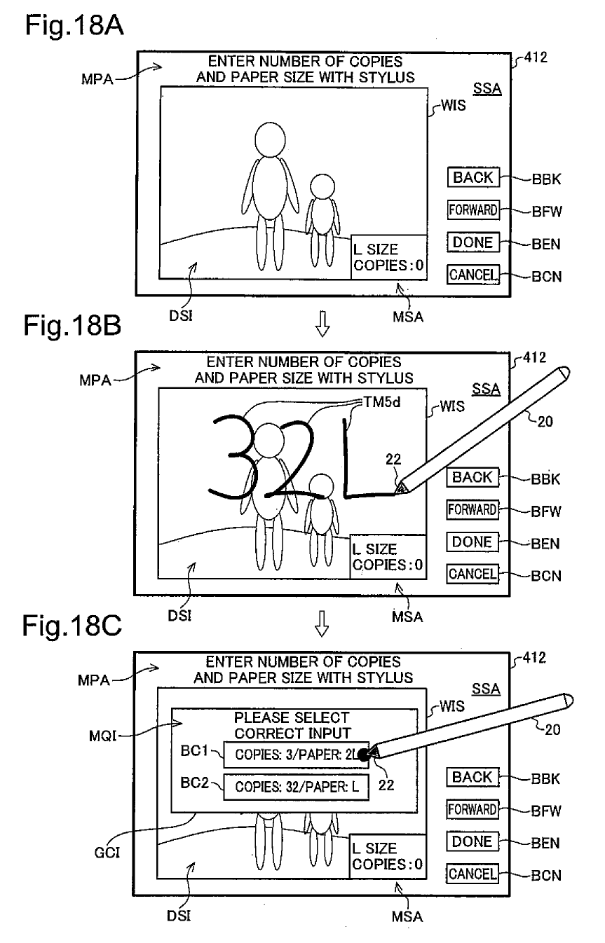

In Step S104d, the printing parameter setting unit 140 displays a copy count/paper size setting screen on the display screen 412. FIG. 18A depicts an exemplary copy count/paper size setting screen SSA displayed on the display screen 412 in Step S104d.

Similar to the copy count setting screen SSN of FIG. 4A, the copy count/paper size setting screen SSA includes a message MPA prompting the user to enter both the desired number of copies and the paper size; four buttons BBK, BFW, BEN, BCN; and an image display area WIS. A target image DSI targeted for setting of the number of copies and the paper size is displayed in the image display area WIS. A settings description message MSA notifying the user of the current settings of number of copies and paper size for the target image DSI is superimposed over the target image DSI in the image display area WIS. In the example of FIG. 18A, the character string “SIZE L” indicating that the paper size is L size, and the character string “COPIES: 0” indicating that the number of copies is zero, are displayed as the settings description message MSA.

FIG. 18B is an illustration depicting a situation in which user has entered the number of copies and paper size on the copy count/paper size setting screen SSA. In the example of FIG. 18B, three handwritten characters TM5d is entered on the copy count/paper size setting screen SSA. In Step S120 of FIG. 17, the handwritten character recognition process executing unit 142 recognizes the character string “32L” from the handwritten character TM5d.

In Step S130d, the printing parameter setting unit 140 determines whether it is possible to unambiguously parse the recognized character string as a character string which specifies a number of copies and a paper size. If it is determined that unambiguous parsing is possible, the process advances to Step S122d. On the other hand, if it is determined that unambiguous parsing is not possible, the process moves to Step S132d.

The character string “32L” recognized from the handwritten characters TM5d can be parsed as two different sets of printing parameters, namely, “3” copies of “2L” size or “32” copies of “L” size. Therefore, in Step S130d of FIG. 17 it is determined that the unambiguous parsing is not possible for the character string “32L,” and Step S132d is executed.

In Step S132d of FIG. 17, the printing parameter setting unit 140 queries the user regarding which of multiple sets of printing parameters parseable from the recognized characters is the correct one. Specifically, the printing parameter setting unit 140 displays on the display screen 412 a dialog box that quires intended input. The printing parameter setting unit 140 then acquires user's instruction input with the stylus 20, and determines the printing parameters (number of copies, paper size) to be set for the image files.

FIG. 18C is an illustration depicting a dialog box GCI displayed on the display screen 412 in Step S132d. The dialog box GCI is displayed on the copy count/paper size setting screen SSA. The dialog box GCI includes a message MQI prompting the user to select correct input; and two buttons BC1, BC2 for selecting either of two possible interpretations. Using the front end 22 of the stylus 20, the user operates either of these buttons BC1, BC2 to indicate selection of the correct input from among the two possible interpretations. In the example of FIG. 18C, using the front end 22 of the stylus 20, the user operates the button BC1 indicating “3” copies of “2L” size. Therefore, with regard to the printing parameters to be set for the image file, the printing parameter setting unit 140 decides that the number of copies is three and that the paper size is 2L size.

In Step S122d of FIG. 17, the printing parameter setting unit 140 sets the number of copies and the paper size of the target image file according to the character string recognized from the handwritten characters in Step S120. After setting the number of copies and the paper size the process returns to Step S104d. In Step S104d, a modified settings description message MSA that reflects the changed settings for number of copies and paper size is displayed over the target image DSI. In the example of FIG. 18A through 18C, a settings description message MSA showing the character string “COPIES: 3” indicating that the number of copies is three, and the character string “SIZE 2L” indicating that the paper size is 2L size is displayed.

In the fifth embodiment, multiple printing parameters (number of copies, paper size) are set all at once in the above manner. This reduces user effort entailed in changing multiple printing parameters together, and makes it easier to set multiple printing parameters.

In the fifth embodiment, the number of copies and the paper size are entered as a continuous character string. It is also possible to enter these printing parameters by a different method. For example, a character indicating the break between the two printing parameters (for example, the characters slash “/”, comma “,” period “.”, or colon “:”) could be entered between the characters respectively representing number of copies and paper size. By entering a break character as the above, input content can be determined all at once. Thus, the two Steps S130d, S132d can be omitted.

### F. Sixth Embodiment

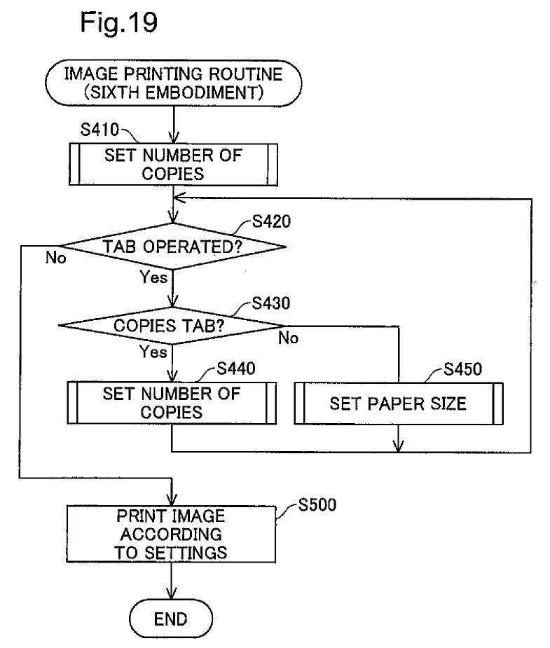

FIG. 19 is a flowchart depicting the image printing routine in the sixth embodiment. The image printing routine of the sixth embodiment differs from the image printing routine in the first embodiment shown in FIG. 2 in that the two Steps S100 and S200 are replaced by five Steps S410 through 450.

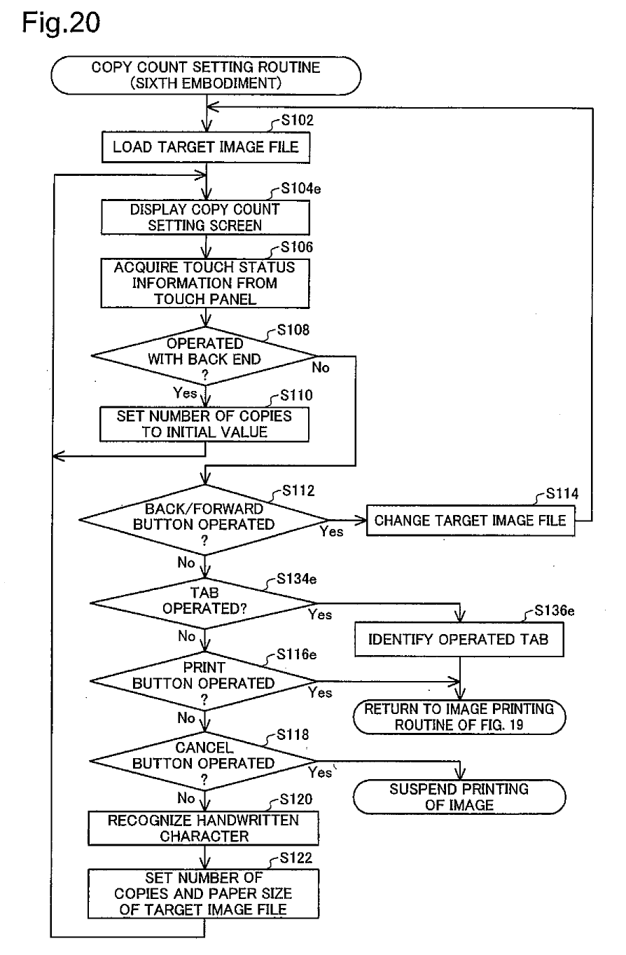

In Step S410, the printing parameter setting unit 140 sets the number of copies for each of the multiple image files GF stored on the memory card MC (FIG. 1). FIG. 20 is a flowchart depicting the copy count setting routine executed in Step S410. The copy count setting routine of the sixth embodiment differs from the copy count setting routine of the first embodiment shown in FIG. 3 in that the two Steps S104 and S116 are replaced respectively by Steps S104e and S116e, and the step S112 is followed by two additional Steps S134e and S136e; it is otherwise similar to the first embodiment. Step S116e differs from Step S116 of FIG. 3 in that the determination as to whether button operation has occurred is made for the “PRINT” button BPR rather than for the “DONE” button BEN (FIG. 4). In other respects, Step S116a is similar to Step S116 and is not discussed in detail.

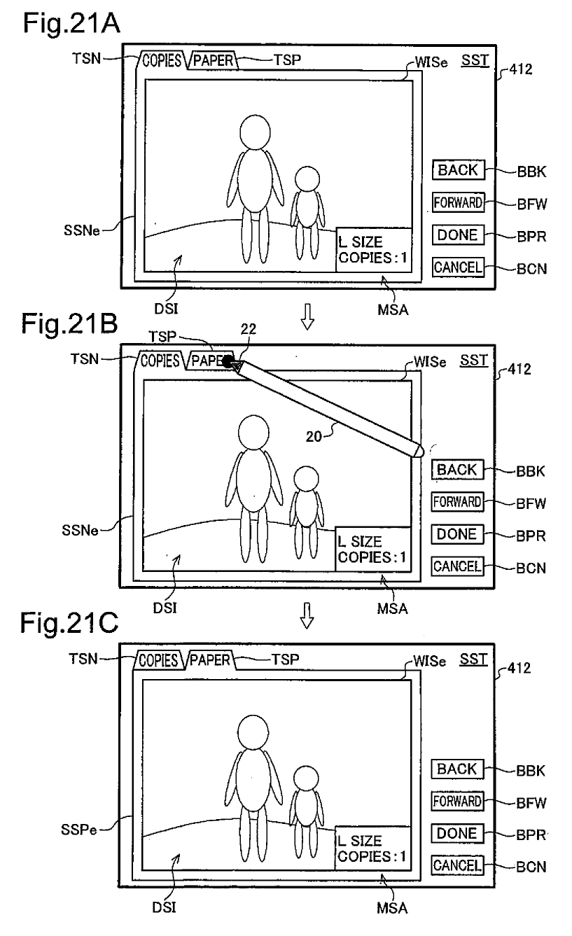

In Step S104e, the printing parameter setting unit 140 displays a copy count setting screen on the display screen 412 (FIG. 1). FIG. 21A shows an exemplary copy count setting screen SSNe displayed on the display screen 412 in Step S104e. In the sixth embodiment, the copy count setting screen SSNe is included in a printing parameter setting screen SST for the purpose of setting the number of copies and the paper size.

The parameter setting screen SST includes the copy count setting screen SSNe; a paper setting screen tab (PAPER tab) TSP; a “BACK” button BBK; a “FORWARD” button BFW; a “PRINT” button BPR; and a “CANCEL” button BCN. An character string “COPIES”, indicating that the printing parameter to be set is the number of copies, is displayed on a tab (COPIES tab) TSN of the copy count setting screen SSNe. Similarly, the character string “PAPER”, indicating that the printing parameter to be set is the paper size is displayed on the PAPER tab TSP. In the example of FIG. 21A, the character string “COPIES” is displayed in larger font size than is the character string “PAPER”, thereby highlighting the fact that number of copies is the printing parameter being set. It is also acceptable for the text in each tab to have substantially the same size, with no highlighting of the printing parameter being set. However, by highlighting the printing parameter being set, the likelihood of the user entering settings in error can be reduced; it is therefore preferable to highlight the display of the printing parameter being set.

As the copy count settings screen SSN of the first embodiment (FIG. 4), the copy count settings screen SSNe includes an image display area WISe. A target image DSI targeted for setting the number of copies is displayed in the image display area WISe. A settings description message MSA notifying the user of the current settings for number of copies and paper size of the target image DSI are superimposed over the target image DSI in the image display area WISe. In the example of FIG. 21A, the character string “SIZE L” indicating that the paper size is L size, and the character string “COPIES: 1” indicating that the number of copies is one, are displayed as the settings description message MSA.

In Step S134e, the printing parameter setting unit 140 determines whether operation of a tab has occurred. Specifically, by analyzing the touch status information acquired in Step S106, the printing parameter setting unit 140 determines whether the touch location of the front end 22 of the stylus 20 to the display screen 412 lies within the area where the two tabs TSN, TSP are displayed. If the touch location of the front end 22 lies within the area where the two tabs TSN, TSP are displayed, the printing parameter setting unit determines that tab operation has occurred, and the process moves to Step S136e. On the other hand, if the touch location of the front end 22 lies outside the area where the two tabs TSN, TSP are displayed, the printing parameter setting unit determines that tab operation has not occurred, and the process advances to Step S116e.

In Step S136e, from the location of the stylus front end as ascertained from the touch status information, the printing parameter setting unit 140 identifies the tab which is operated. After identification of the operated tab, the process advances to the image printing routine of FIG. 19.

FIG. 21B depicts user's operation of the PAPER tab TSP. When the user touches the PAPER tab TSP displayed on the printing parameter setting screen SST with the front end 22 of the stylus 20, in Step S134e of FIG. 20 it is determined that the operated tab is the PAPER tab TSP.

When the process returns from the copy count setting routine shown in FIG. 20 to the image printing routine shown in FIG. 19, Step S420 is executed. In Step S420, the printing parameter setting unit 140 determines whether the process has returned through tab operation. If it determined that the process has returned through tab operation, the process advances to Step S430. On the other hand, if it is determined that the process has not returned through tab operation, i.e., that the process has returned through operation of the “PRINT” button BPR of FIG. 21A through 21C, the process moves to Step S500.

In Step S430, the printing parameter setting unit 140 determines whether the COPIES tab TSN (FIG. 21A through 21C) is the operated tab. If it is determined that the COPIES tab TSN is the operated tab, the process advances to Step S440. On the other hand, if it is determined that the COPIES tab TSN is not the operated tab, i.e. that the PAPER tab TSP (FIG. 21A through 21C) is the operated tab, the process moves to Step S440.

In Step S440, the printing parameter setting unit 140 sets the number of copies through execution of the copy count setting routine of FIG. 20. Once the process returns from the copy count setting routine executed in Step S440, the process returns to Step S420.

In Step S450, the printing parameter setting unit 140 sets the paper size for each of the multiple image files GP stored on the memory card MC (FIG. 1). The paper setting routine executed by the printing parameter setting unit 140 for the purpose of setting paper size is similar to the copy count setting routine of FIG. 20, so it is not illustrated or discussed here.

FIG. 21C shows a paper setting screen SSPe displayed during execution of the paper setting routine. As the copy count setting screen SSNe shown in FIG. 21A, the paper setting screen SSPe is displayed on the printing parameter setting screen SST. On the printing parameter setting screen SST of FIG. 21C, the character string “PAPER” displayed on the PAPER tab TSP has larger font size than the character string “COPIES” displayed on the COPIES tab TSN, thereby highlighting that the printing parameter to be set is the paper size. In other respects, the printing parameter setting screen SST which displays the paper setting screen SSPe of FIG. 21C, and the printing parameter setting screen SST which displays the copy count setting screen SSNe of FIG. 21C, are similar.

Through user operation of the two tabs TSN, TSP (FIG. 21) with the stylus 20 in this way, it is possible to switch arbitrarily between the copy count setting screen SSNe and the paper setting screen SSPe. The user therefore is able to set the number of copies and set the paper size settings in any order, making it easier to set multiple printing parameters (copy count/paper size).

In the sixth embodiment, in each of the copy count setting screen SSNe and the paper setting screen SSPe a single target image DSI of which printing parameters are being set is displayed. It is also acceptable to display multiple images on the setting screens SSNe, SSPe. In this case, settings of number of copies and of paper size can be made in the manner shown in the second embodiment to the fourth embodiment.

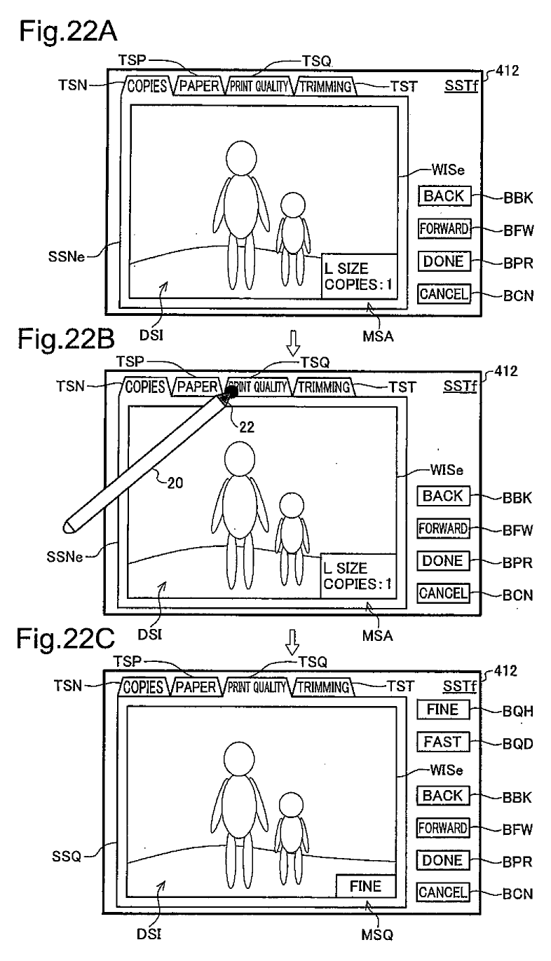

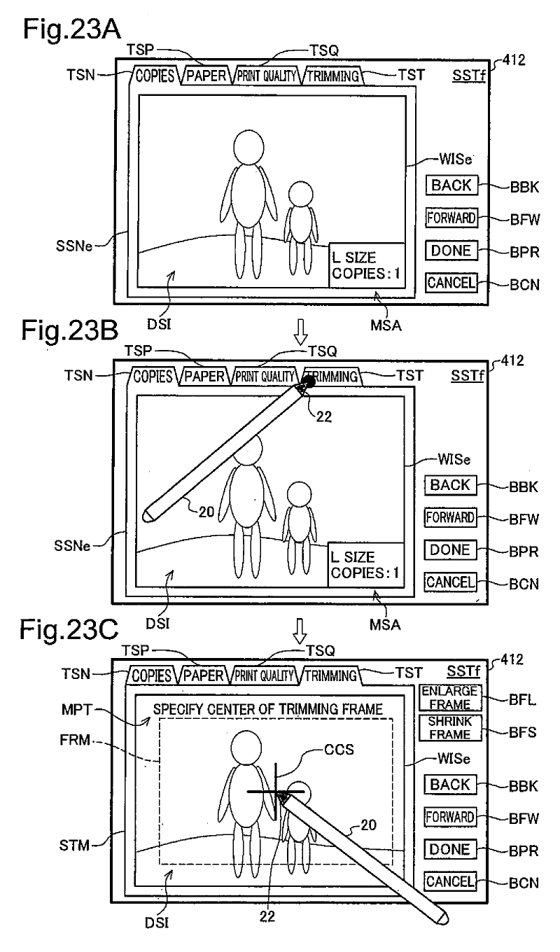

The sixth embodiment is constituted so that the copy count setting screen SSNe and the paper setting screen SSPe are switchable on the printing parameter setting screen SST. Other setting screens may also be provided by way of additional switchable screens. FIG. 22A through 22C and FIG. 23A through 23C depict a printing parameter setting screen SSTf that, in addition to the copy count setting screen SSNe and the paper setting screen SSPe, is switchable to a print quality setting screen for setting quality of printed images (print quality), and to a trimming setting screen for setting the method of trimming images during printing.

FIG. 22A depicts the copy count setting screen SSNe prior to switching of the setting screen. At this time, four buttons, namely, the copy count setting screen SSNe, a PAPER tab TSP, a print quality setting screen tab (PRINT QUALITY tab) TSQ, and a trimming setting screen tab (TRIMMING tab) TST are displayed on the printing parameter setting screen SSTf. The copy count setting screen SSNe is the same as in FIG. 21.

As shown in FIG. 22B, when the user operates the PRINT QUALITY tab TSQ with the front end 22 of the stylus 20, a print quality setting screen SSQ is displayed on the printing parameter setting screen SSTf, as shown in FIG. 22C. At this time, a “FINE” button BQH for instructing printing at high quality, and a “FAST” button BQD for instructing printing at draft quality, will be displayed on the printing parameter setting screen SSTf.

In similar manner to the copies setting screen SSNe, a target image DSI targeted for setting of print quality is displayed in an image display area WISe of the print quality setting screen SSQ. Also, a print quality setting message MSQ notifying the user of the current print quality setting value is superimposed on the target image DSI. In the example of FIG. 22C, the print quality of the target image DSI is set so as to print at high print quality, and the character string “FINE” is displayed as the print quality setting message MSQ. At this time, if the user operates the “FAST” button BQD, settings is modified so that the target image DSI is printed at draft quality, and the character string “DRAFT” is displayed as the print quality setting message MSQ.

FIG. 23A is the same as FIG. 22A. FIG. 23A depicts the copies setting screen SSNe prior to switching of the setting screen. As shown in FIG. 23B, if the TRIMMING tab TST is operated with the front end 22 of the stylus 20 at this time, a trimming setting screen STM is displayed on the printing parameter setting screen SSTf, as shown in FIG. 23C. Two buttons BFL and BDS are displayed on the printing parameter setting screen SSTf as well.

In similar manner to the copies setting screen SSNe, a target image DSI targeted for setting of trimming is displayed in an image display area WISe of the trimming setting screen STM. In the image display area WISe, a trimming frame FRM, a cross-shaped cursor CCS indicating the center position of the trimming frame FRM, and a message MPT prompting the user to specify the center position of the trimming frame FRM are superimposed over the target image DSI. At this time, by touching the display screen 412 with the front end 22 of the stylus 20, the user can set the touch location as the center position of the trimming frame FRM.

In the condition of FIG. 23C, when the user operates the “ENLARGE FRAME” button BFL with the front end 22 of the stylus 20, the trimming frame FRM is enlarged by a prescribed ratio (e.g. 1.1x). On the other hand, when the user operates the “SHRINK FRAME” button BFS with the front end 22 of the stylus 20, the trimming frame FRM shrinks by a prescribed ratio (e.g. 1/1.1x).

In the sixth embodiment, by providing respective tabs for multiple setting screens for the purpose of respectively setting multiple printing parameters, the user is able to select any of the multiple setting screens and set various printing parameters from the selected setting screen. It is therefore possible for printing parameters to be set more easily, even with a larger number of settable printing parameters.

### G. Modifications

The invention is not limited to the embodiment discussed above, and may be reduced to practice in various other forms without departing from the spirit thereof, such as the following modifications, for example.

### G1. Modification 1

In the first embodiment, the printing parameters of the target image DSI are set by entering characters on a single target image DSI displayed on the display screen 412 (FIG. 1). It is also possible to display multiple images DD1 through DD9 on the display screen 412 as shown in FIG. 9, and to set the printing parameters respectively for each of the multiple images DD1 through DD9 by entering characters over the individual displayed images. In this case, to set the number of copies, for example, if the numeral “2” is entered on the image DD1 and the numeral “3” is entered on the image DD2, the number of copies of the image DD1 is set to two, and the number of copies of the image DD2 is set to three. The determination as to whether entry of printing parameters is completed can be made, for example, by providing a button for the purpose of confirming the entered printing parameters on the display screen 412, and detecting user's operation of the button. The determination as to whether entry of printing parameters is completed can also be made if a continuous time interval has elapsed without touch by the stylus 20.

### G2. Modification 2

In the embodiments hereinabove, printing parameters are set on the basis of character strings recognized from handwritten characters entered on the display screen 412 (FIG. 1) with a stylus 20 (FIG. 1). The printing parameters may also be set on the basis of information input by some other method. For example, an “INCLEASE” button instructing an increase in the number of copies and a “DECREASE” button instructing a decrease in the number of copies may be provided on the copy count setting screen, with the number of copies being set according to operation of these buttons using the stylus 20. Also, it is possible to provide the paper setting screen with multiple buttons respectively specifying multiple paper sizes, and to set the paper size according to operation of these buttons using the stylus 20.

In the case where a message indicating the current setting of a printing parameter is displayed on the printing parameter setting screen, it is possible to display a printing parameter setting dialog box in response to touch of the message display area with the front end 22 of the stylus 20. Also, in the case where messages indicating settings for multiple printing parameters is displayed, it is possible to display a setting dialog box for a printing parameter corresponding to touched message with the front end 22 of the stylus 20 within the messages.

### G3. Modification 3

In the embodiments hereinabove, a stylus 20 provided with the printer 10 (FIG. 1) is used to set the printing parameters. It is also possible to use any stylus-shaped object able to enter characters on the display screen 412 of the touch screen panel 410 in order to set the printing parameters. In this case, setting of printing parameters can be carried out by treating touch of the stylus-shaped object in the same way as touch of the front end 22 of the stylus 20. On the other hand, for a process carried out with the stylus back end 24, a button for the purpose of executing the process can be displayed on the display screen 412 and the process executed through operation of the button. As the stylus-shaped objects, a finger, ball-point pen, or any other object able to enter characters may be used.

### G4. Modification 4

While the preceding examples described the printing parameter setting method of the present invention in terms of implementation in a printer, the printing parameter setting method of the invention can be implemented in any apparatus that has a touch screen panel and is capable of printing images. The present invention can also be implemented in multifunction devices that have printer/scanner/copier functions.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image printing apparatus for printing an image according to a preset printing parameter comprising:
a touch screen panel having a display screen and a touch information acquiring unit configured to acquire touch information, the touch information representing a touching status of a stylus-shaped object to the display screen; and
a printing parameter setting unit configured to set a printing parameter of an image according to the touch information acquired by the touch information acquiring unit;
wherein the printing parameter setting unit includes:
an image display controller configured to display a setting-target image which is targeted for setting of the printing parameter on the display screen; and
a handwritten character recognition unit configured to recognize a handwritten character according to the touch information, the handwritten character being entered by the stylus-shaped object on the display screen displaying the setting-target image, and
wherein the printing parameter setting unit sets the printing parameter according to a recognized character string recognized by the handwritten character recognition unit.

2. The image printing apparatus according to claim 1 wherein
the printing parameter setting unit is configured:
to display on the display screen a plurality of printing-target images which are targeted for printing;
to acquire a character entry region within the display screen, the character entry region being determined through the handwritten character representing the recognized character string being entered on the display screen; and
to set printing parameters for one or more setting-target images according to the recognized character string, the one or more setting-target images being one or more of the printing-target image which are displayed at location overlapping the character entry region among the plurality of printing-target images displayed on the display screen.

3. The image printing apparatus according to claim 1 wherein
the printing parameter setting unit is configured:
to display on the display screen a plurality of printing-target images which are targeted for printing;
to acquire a setting-target selection instruction for selecting one or more setting-target images from among the plurality of printing-target images being displayed on the display screen; and
to set the printing parameter according to the recognized character string for each of the one or more setting-target images specified by the setting-target selection instruction.

4. The image printing apparatus according to claims 1 wherein
the printing parameter setting unit is configured:
to allow input, as the recognized character string, of a multiple item setting character string enabling setting of a plurality of printing parameters; and
if the multiple item setting character string is parseable as a plurality of mutually different printing parameter sets, to acquire a printing parameter specifying instruction by the user, the printing parameter specifying instruction specifying one of the printing parameter set among the plurality of printing parameter sets, and to select one of the plurality of printing parameter sets according to the printing parameter specifying instruction.

5. The image printing apparatus according to claims 1 wherein
the stylus-shaped object is a stylus having a first end and second end, the touch screen panel being capable of detecting whether the display screen is touched by the first end or the second end of the stylus-shaped object; and
the printing parameter setting unit is configured:
if touch of the first end of the stylus to the display screen is detected, to set the printing parameter according to the recognized character string; and
if touch of the second end of the stylus to the display screen is detected, to set the printing parameter to a previously set printing parameter.

6. The image printing apparatus according to claims 1 wherein
the stylus-shaped object is a stylus having a first end and a second end, the touch screen panel being capable of detecting whether the display screen is touched by the first end or the second end of the stylus-shaped object; and
the printing parameter setting unit is configured:
if touch of the first end of the stylus to the display screen is detected, to set the printing parameter on the basis of the recognized character string; or
if touch of the second end of the stylus to the display screen is detected, to set the printing parameter to a preset default printing parameter.

7. A method for setting a printing parameter of an image in an image printing apparatus, the image printing apparatus including a touch screen panel having a display screen the method comprising the step of:
setting a printing parameter of an image according to touch information representing a touching status of a stylus-shaped object to the display screen,
wherein the step of setting the printing parameter includes the steps of:
displaying a setting-target image which is targeted for setting of the printing parameter on the display screen;
recognizing a handwritten character according to the touch information, the handwritten character being entered by the stylus-shaped object on the display screen displaying the setting-target image; and
setting the printing parameter according to a recognized character string recognized by the step of recognizing the handwritten character.
